(19) United States
(12) Patent Application Publication
(10) Pub. No.: US 2020/0389574 A1
(43) Pub. Date: Dec. 10, 2020

(54) USB CAMERA

(71) Applicant: Nextedge Labs, Inc., Taipei City (TW)

(72) Inventor: Chao-Han Chang, Taipei City (TW)

(21) Appl. No.: 16/431,740

(22) Filed: Jun. 5, 2019

(51) Int. Cl. H04N 5/225; G03B 17/56; F16M 11/22; F16M 11/20

(52) U.S. Cl. CPC H04N 5/2253; G03B 17/561; F16M 2200/068; F16M 11/2035; F16M 2200/08; F16M 11/22

(57) ABSTRACT

A USB camera includes a foldable base, a bracket, a support frame, and a camera module. The foldable base includes a primary plate and at least one secondary plate. The at least one secondary plate is configured to rotate with respect to the primary plate, such that the at least one secondary plate is selectively folded or expanded with respect to the primary plate. The bracket is disposed on the primary plate. The support frame is connected to the bracket. The camera module is connected to the support frame. The camera module has a USB port.

### BACKGROUND OF THE INVENTION

### 1. Field of the Invention

The invention relates to a universal serial bus (USB) camera and, more particularly, to a USB camera with a foldable base.

### 2. Description of the Prior Art

A USB camera, such as a webcam, has been widely used by a lot of people in their daily lives. In general, the USB camera is fastened on an object (e.g. a cover of a notebook computer, a monitor, etc.) in a clamping or engaging manner. In other words, the USB camera cannot be placed on a plane individually since the USB camera does not have a base. Therefore, the USB camera lacks flexibility in use and it is very inconvenient for some purposes.

### SUMMARY OF THE INVENTION

The invention provides a USB camera with a foldable base, so as to solve the aforesaid problems.

According to an embodiment of the invention, a USB camera comprises a foldable base, a bracket, a support frame, and a camera module. The foldable base comprises a primary plate and at least one secondary plate. The at least one secondary plate is configured to rotate with respect to the primary plate, such that the at least one secondary plate is selectively folded or expanded with respect to the primary plate. The bracket is disposed on the primary plate. The support frame is connected to the bracket. The camera module is connected to the support frame. The camera module has a USB port.

As mentioned in the above, a user may place the USB camera of the invention on a plane individually by the foldable base instead of being fastened on an object (e.g. a cover of a notebook computer, a monitor, etc.). Furthermore, the user may selectively fold or expand the secondary plate with respect to the primary plate, so as to adjust the size of the foldable base for different purposes. For example, when a user uses the USB camera, the user may expand the secondary plate with respect to the primary plate to enlarge the foldable base, so as to place the USB camera on a plane by the foldable base more stably. After using the USB camera, the user may fold the secondary plate with respect to the primary plate to reduce the foldable base, so as to facilitate storage and/or transportation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a USB camera according to an embodiment of the invention.

FIG. 2 is an exploded view illustrating the USB camera shown in FIG. 1.

FIG. 3 is an exploded view illustrating the USB camera shown in FIG. 1 from another viewing angle.

FIG. 4 is a perspective view illustrating the foldable base shown in FIG. 1 after being folded.

FIG. 5 is a perspective view illustrating the camera module shown in FIG. 4 oriented toward another direction.

FIG. 6 is a perspective view illustrating the support frame shown in FIG. 4 after being folded on the foldable base.

FIG. 7 is a perspective view illustrating a height increasing member configured to connect the bracket and the support frame shown in FIG. 1.

FIG. 8 is an exploded view illustrating the USB camera shown in FIG. 7.

FIG. 9 is an exploded view illustrating the USB camera shown in FIG. 7 from another viewing angle.

FIG. 10 is a perspective view illustrating a foldable base according to another embodiment of the invention.

### DETAILED DESCRIPTION

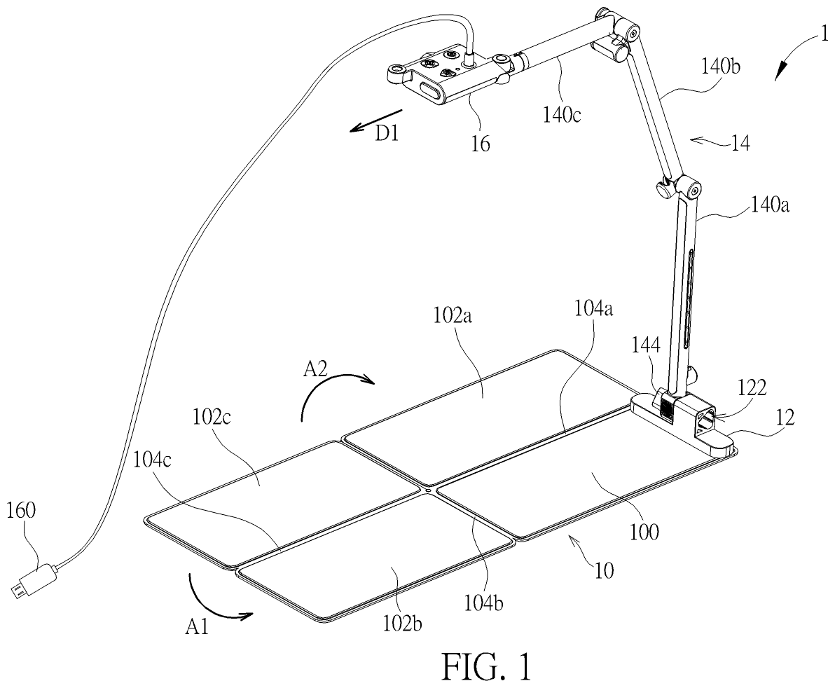

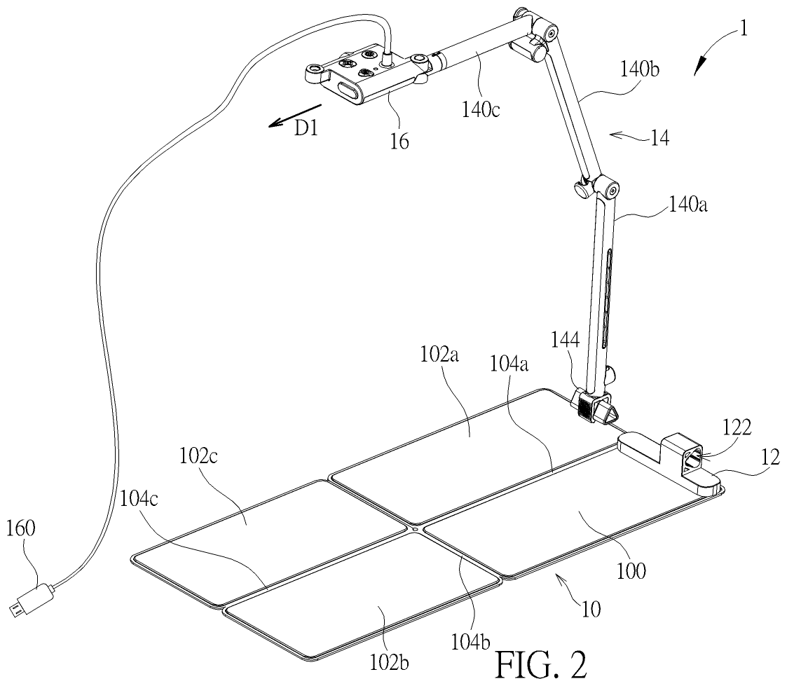

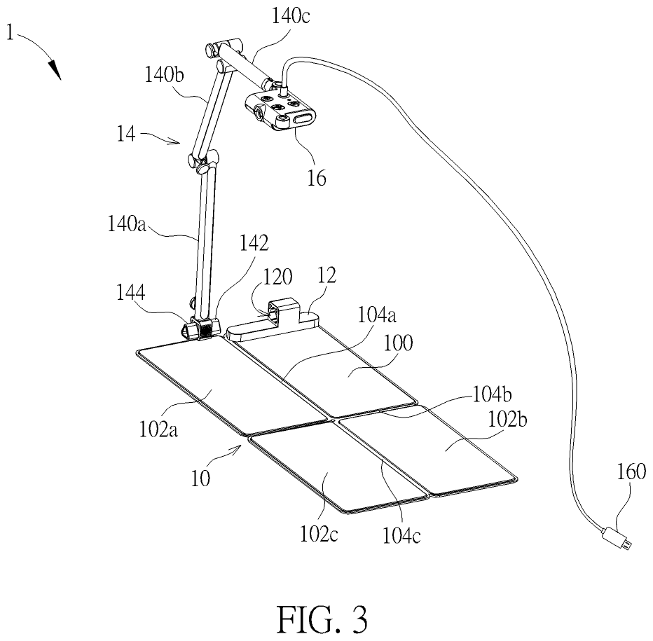

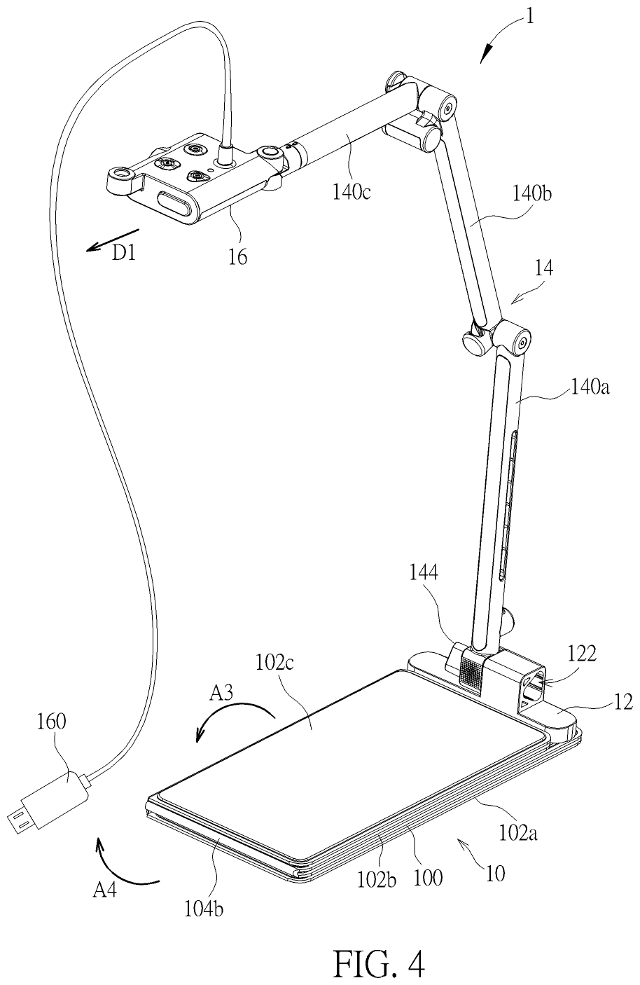

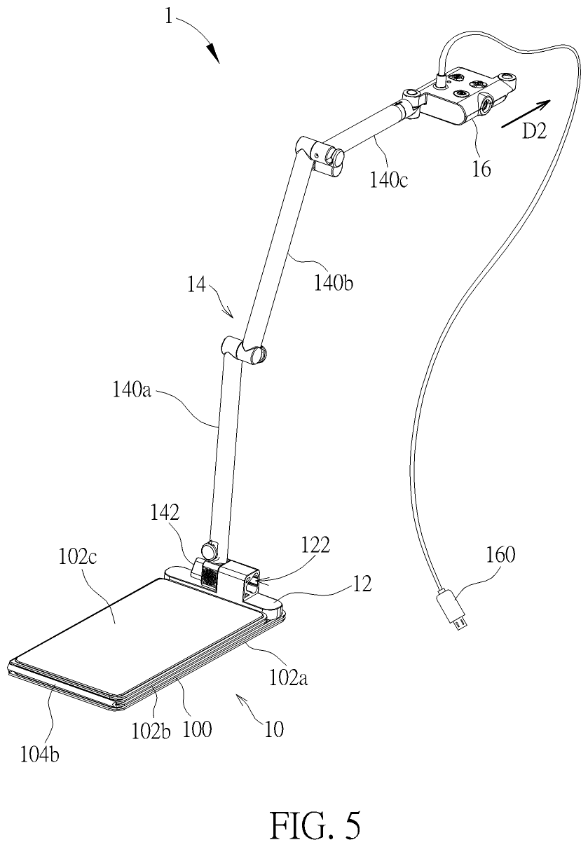

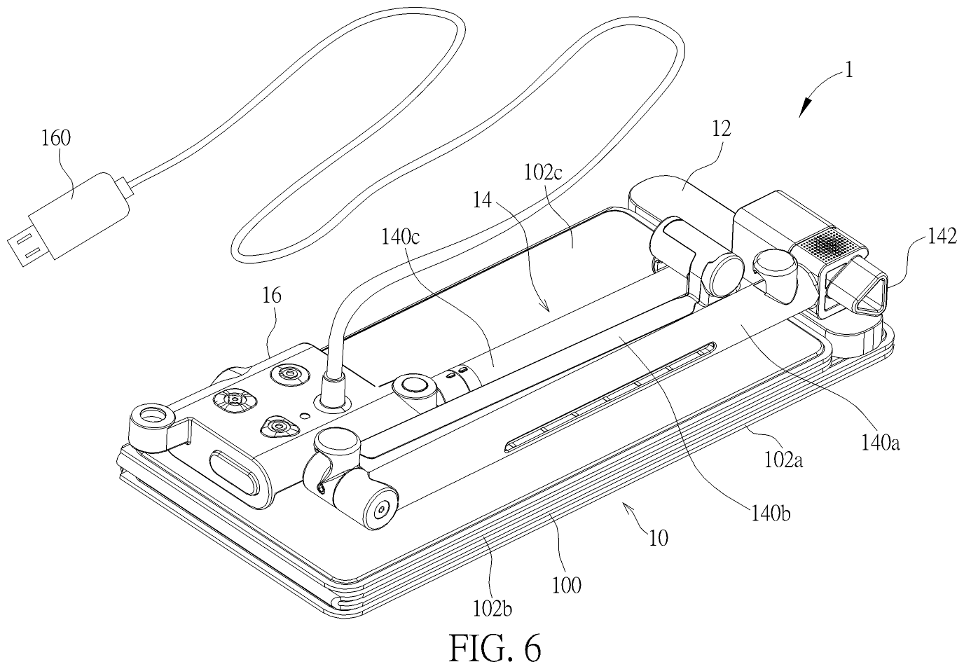

Referring to FIGS. 1 to 6, FIG. 1 is a perspective view illustrating a USB camera 1 according to an embodiment of the invention, FIG. 2 is an exploded view illustrating the USB camera 1 shown in FIG. 1, FIG. 3 is an exploded view illustrating the USB camera 1 shown in FIG. 1 from another viewing angle, FIG. 4 is a perspective view illustrating the foldable base 10 shown in FIG. 1 after being folded, FIG. 5 is a perspective view illustrating the camera module 16 shown in FIG. 4 oriented toward another direction, and FIG. 6 is a perspective view illustrating the support frame 14 shown in FIG. 4 after being folded on the foldable base 10.

As shown in FIGS. 1 to 3, the USB camera 1 comprises a foldable base 10, a bracket 12, a support frame 14, and a camera module 16. The foldable base 10 comprises a primary plate 100 and three secondary plates 102a, 102b, 102c. It should be noted that the foldable base 10 may comprise one or more secondary plates (i.e. at least one secondary plate) according to practical applications, so the invention is not limited to the embodiment described above.

The secondary plates 102a, 102b, 102c are pivotally connected to the primary plate 100 directly or indirectly and are configured to rotate with respect to the primary plate 100, such that the secondary plates 102a, 102b, 102c may be selectively folded or expanded with respect to the primary plate 100, as shown in FIGS. 1 and 4. In this embodiment, for example, the secondary plate 102a may be pivotally connected to the primary plate 100 by a connecting portion 104a, the secondary plate 102b may be pivotally connected to the primary plate 100 by a connecting portion 104b, and the secondary plate 102c may be pivotally connected to the secondary plate 102b by a connecting portion 104c. In other words, the secondary plates 102a, 102b are pivotally connected to the primary plate 100 directly, and the secondary plate 102c is pivotally connected to the primary plate 100 indirectly through the secondary plate 102b.

As shown in FIG. 1, the secondary plate 102a may rotate with respect to the primary plate 100 in a direction of an arrow A1, the secondary plate 102c may rotate with respect to the secondary plate 102b in the direction of the arrow A1, and the secondary plate 102b may rotate with respect to the primary plate 100 in a direction of an arrow A2, so as to fold the foldable base 10 into a folded state shown in FIG. 4. In this embodiment, the secondary plates 102a, 102b, 102c may fully overlap with the primary plate 100 when the secondary plates 102a, 102b, 102c are folded with respect to the primary plate 100. On the other hand, as shown in FIG. 4, the secondary plate 102b may rotate with respect to the primary plate 100 in a direction of an arrow A3, the secondary plate 102a may rotate with respect to the primary plate 100 in a direction of an arrow A4, and the secondary plate 102c may rotate with respect to the secondary plate 102b in the direction of the arrow A4, so as to expand the foldable base 10 into an expanded state shown in FIG. 1.

The bracket 12 is disposed on the primary plate 100. In this embodiment, the bracket 12 may have a first engaging portion 120 and a third engaging portion 122 opposite to the first engaging portion 120, as shown in FIGS. 1 to 3.

The support frame 14 is connected to the bracket 12. In this embodiment, the support frame 14 may comprise a plurality of support members 140a, 140b, 140c pivotally connected to each other and configured to rotate with respect to each other, such that the support frame 14 may be selectively folded or expanded with respect to the foldable base 10, as shown in FIGS. 4 and 6. It should be noted that the number of the support members may be determined according to practical applications, so the invention is not limited to the embodiment described above.

Furthermore, the support frame 14 may have a second engaging portion 142 and a fourth engaging portion 144 opposite to the second engaging portion 142, wherein the second engaging portion 142 and the fourth engaging portion 144 may be disposed on an end of the support member 140a, as shown in FIGS. 1 to 3. The second engaging portion 142 may be detachably engaged with one of the first engaging portion 120 and the third engaging portion 122, such that the support frame 14 may be detachably connected to the bracket 12. Similarly, the fourth engaging portion 144 may be detachably engaged with one of the first engaging portion 120 and the third engaging portion 122, such that the support frame 14 may be detachably connected to the bracket 12.

In this embodiment, the first engaging portion 120 and the third engaging portion 122 may be recesses, and the second engaging portion 142 and the fourth engaging portion 144 may be protrusions correspondingly. However, in another embodiment, the first engaging portion 120 and the third engaging portion 122 may be protrusions, and the second engaging portion 142 and the fourth engaging portion 144 may be recesses correspondingly.

The camera module 16 is connected to the support frame 14. In this embodiment, the camera module 16 may be connected to the support member 140c of the support frame 14. A user may rotate at least one of the support members 140a, 140b, 140c to adjust the position of the camera module 16. Furthermore, the camera module 16 has a USB port 160, such that the camera module 16 may be connected to an electronic device (e.g. a computer, a projector, etc.) through the USB port 160. In general, the camera module 16 may be further equipped with some necessary hardware or software components for specific purposes, such as a controller, an image sensor, a lens, a memory, a power supply, applications, a communication module, etc., and it depends on practical applications.

When a user uses the USB camera 1, the user may place the USB camera 1 on a plane individually by the foldable base 10. Furthermore, the user may selectively fold or expand the secondary plates 102a, 102b, 102c with respect to the primary plate 100, so as to adjust the size of the foldable base 10 for different purposes. For example, the user may expand the secondary plates 102a, 102b, 102c with respect to the primary plate 100 to enlarge the foldable base 10 (as shown in FIG. 1), so as to place the USB camera 1 on a plane by the foldable base 10 more stably. When the foldable base 10 are expanded, the surfaces of the primary plate 100 and the secondary plates 102a, 102b, 102c may be flush with each other, so as to form a flat and enlarged platform. Accordingly, the user may place an object (e.g. a document, a book, a picture, etc.) on the flat and enlarged platform and under the camera module 16. Needless to say, the user may fold the secondary plates 102a, 102b, 102c with respect to the primary plate 100 to reduce the foldable base 10 (as shown in FIG. 4) and then place the USB camera 1 on a plane by the foldable base 10 as long as the USB camera 1 does not topple over.

As shown in FIGS. 1 and 4, the camera module 16 may be oriented toward a first direction D1 when the second engaging portion 142 of the support frame 14 is detachably engaged with the first engaging portion 120 of the bracket 12. As shown in FIG. 5, the camera module 16 may be oriented toward a second direction D2 when the fourth engaging portion 144 of the support frame 14 is detachably engaged with the first engaging portion 120 of the bracket 12. The first direction D1 is opposite to the second direction D2. That is to say, the user may orient the camera module 16 toward different directions by means of engaging the second engaging portion 142 or the fourth engaging portion 144 of the support frame 14 with the first engaging portion 120 of the bracket 12.

For example, when the user needs to draw or write under the camera module 16 with a large and flat plane, the user may orient the camera module 16 toward the second direction D2 by means of engaging the fourth engaging portion 144 of the support frame 14 with the first engaging portion 120 of the bracket 12, so as to prevent the foldable base 10 from interfering with the action of the user. Furthermore, the foldable base 10 may be folded to balance the weight of the USB camera 1, so as to place the USB camera 1 shown in FIG. 5 on a plane more stably.

After using the USB camera 1, the user may fold the secondary plates 102a, 102b, 102c with respect to the primary plate 100 to reduce the foldable base 10 and fold the support members 140a, 140b, 140c with respect to each other. Then, the user may detach the support frame 14 from the bracket 12 and engage the fourth engaging portion 144 of the support frame 14 with the third engaging portion 122 of the bracket 12. Consequently, as shown in FIG. 6, the size of the USB camera 1 is reduced substantially, so as to facilitate storage and/or transportation.

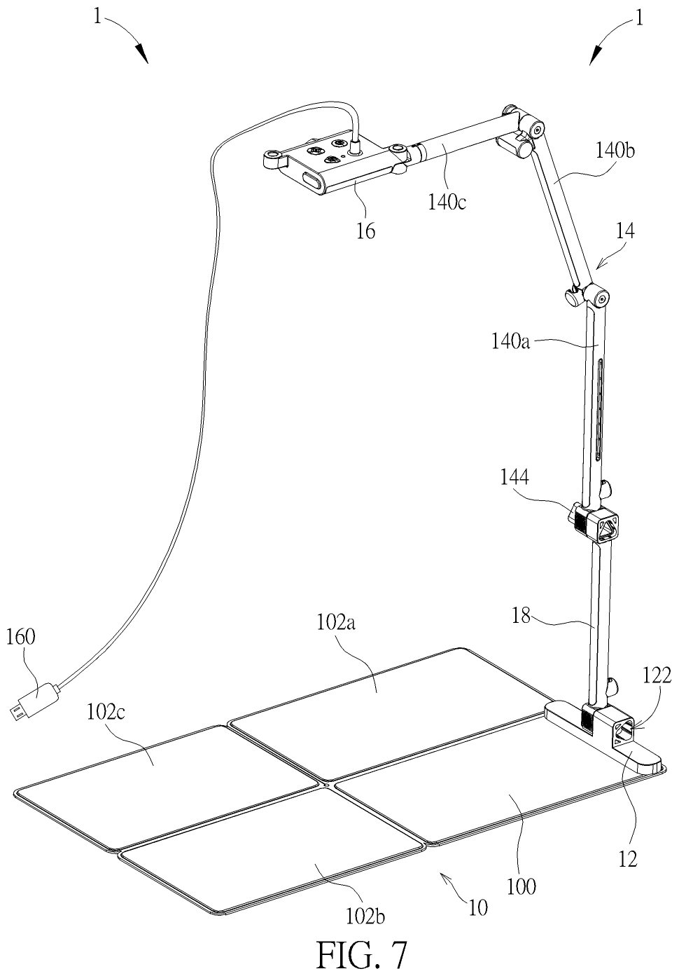

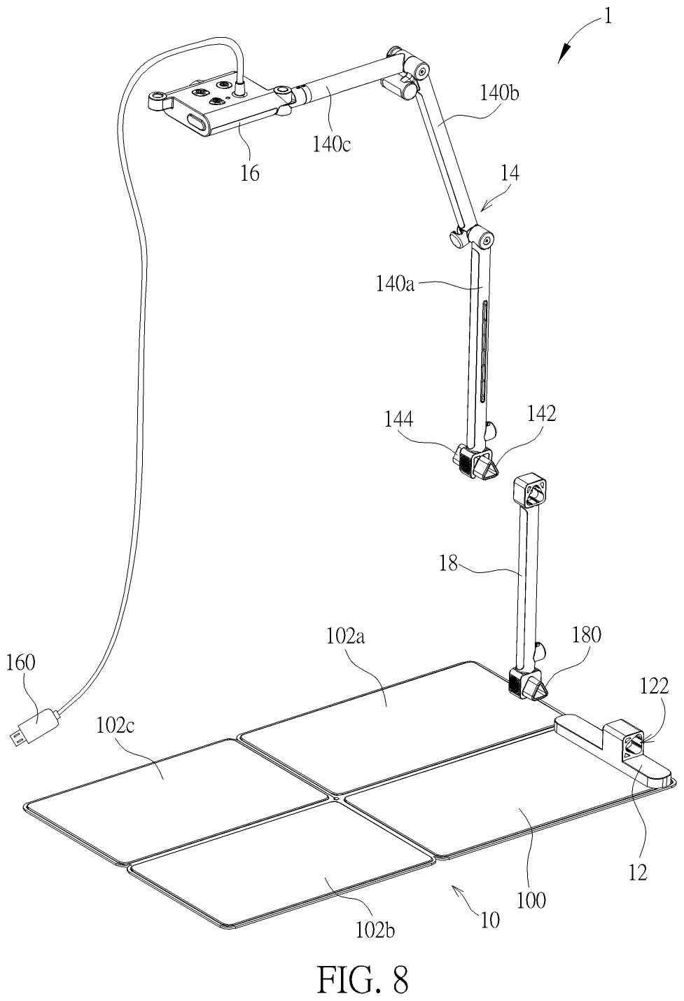

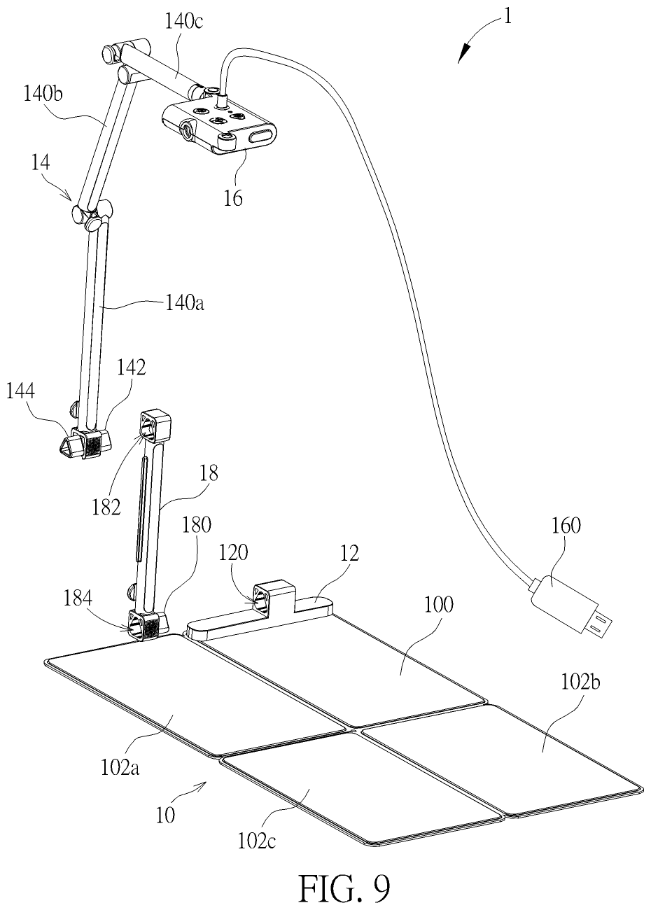

Referring to FIGS. 7 to 9, FIG. 7 is a perspective view illustrating a height increasing member 18 configured to connect the bracket 12 and the support frame 14 shown in FIG. 1, FIG. 8 is an exploded view illustrating the USB camera 1 shown in FIG. 7, and FIG. 9 is an exploded view illustrating the USB camera 1 shown in FIG. 7 from another viewing angle.

As shown in FIGS. 7 to 9, the USB camera 1 may further comprise a height increasing member 18, wherein the height increasing member 18 may be connected to the bracket 12 and the support frame 14 may be connected to the height increasing member 18 after the support frame 14 is detached from the bracket 12. In other words, the user may use the height increasing member 18 to connect the bracket 12 and the support frame 14, so as to enlarge a field of view (FOV) of the camera module 16. As shown in FIGS. 8 and 9, opposite ends of the height increasing member 18 may have a fifth engaging portion 180 and a sixth engaging portion 182, wherein the fifth engaging portion 180 may be a protrusion and the sixth engaging portion 182 may be a recess. The user may engage the fifth engaging portion 180 of the height increasing member 18 with the first engaging portion 120 of the bracket 12 and engage the second engaging portion 142 of the support frame 14 with the sixth engaging portion 182 of the height increasing member 18, so as to increase the height of the camera module 16 and enlarge the FOV of the camera module 16.

In this embodiment, as shown in FIG. 9, the height increasing member 18 may further have a seventh engaging portion 184 opposite to the fifth engaging portion 180, wherein the seventh engaging portion 184 may be a recess. Accordingly, the user may detach the support frame 14 from the height increasing member 18 and engage the second engaging portion 142 of the support frame 14 with the seventh engaging portion 184 of the height increasing member 18. That is to say, the user does not need to detach the height increasing member 18 from the bracket 12 if the height increasing member 18 is not required.

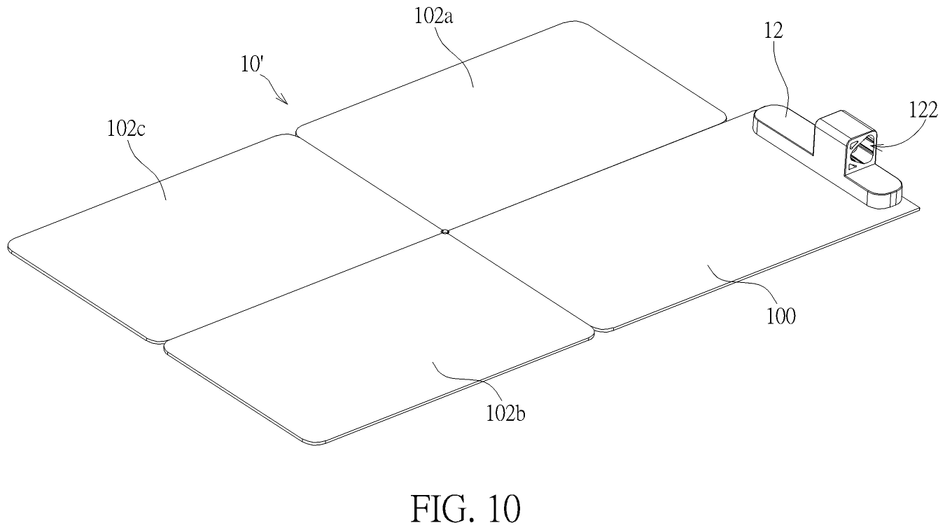

Referring to FIG. 10, FIG. 10 is a perspective view illustrating a foldable base 10′ according to another embodiment of the invention. As shown in FIG. 10, the secondary plates 102a, 102b may abut against the primary plate 100 tightly and the secondary plate 102c may abut against the secondary plates 102a, 102b tightly when the secondary plates 102a, 102b, 102c are expanded with respect to the primary plate 100. Accordingly, after replacing the aforesaid foldable base 10 by the foldable base 10′, the USB camera 1 may be placed on a plane by the foldable base 10′ more stably since there are no gaps between the primary plate 100 and the secondary plates 102a, 102b, 102c.

As mentioned in the above, a user may place the USB camera of the invention on a plane individually by the foldable base instead of being fastened on an object (e.g. a cover of a notebook computer, a monitor, etc.). Furthermore, the user may selectively fold or expand the secondary plate with respect to the primary plate, so as to adjust the size of the foldable base for different purposes. For example, when a user uses the USB camera, the user may expand the secondary plate with respect to the primary plate to enlarge the foldable base, so as to place the USB camera on a plane by the foldable base more stably. After using the USB camera, the user may fold the secondary plate with respect to the primary plate to reduce the foldable base, so as to facilitate storage and/or transportation. Moreover, the user may use the height increasing member to connect the bracket and the support frame, so as to enlarge the FOV of the camera module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A USB camera comprising:
a foldable base comprising a primary plate and at least one secondary plate, the at least one secondary plate being configured to rotate with respect to the primary plate, such that the at least one secondary plate is selectively folded or expanded with respect to the primary plate;
a bracket disposed on the primary plate;
a support frame connected to the bracket; and
a camera module connected to the support frame, the camera module having a USB port.

2. The USB camera of claim 1, wherein the at least one secondary plate fully overlaps with the primary plate when the at least one secondary plate is folded with respect to the primary plate.

3. The USB camera of claim 1, wherein the bracket has a first engaging portion, the support frame has a second engaging portion, and the second engaging portion is detachably engaged with the first engaging portion, such that the support frame is detachably connected to the bracket.

4. The USB camera of claim 3, wherein the bracket has a third engaging portion opposite to the first engaging portion, and the second engaging portion is detachably engaged with one of the first engaging portion and the third engaging portion, such that the support frame is detachably connected to the bracket.

5. The USB camera of claim 4, wherein the support frame has a fourth engaging portion opposite to the second engaging portion, and the fourth engaging portion is detachably engaged with one of the first engaging portion and the third engaging portion, such that the support frame is detachably connected to the bracket.

6. The USB camera of claim 5, wherein the camera module is oriented toward a first direction when the second engaging portion is detachably engaged with the first engaging portion, the camera module is oriented toward a second direction when the fourth engaging portion is detachably engaged with the first engaging portion, and the first direction is opposite to the second direction.

7. The USB camera of claim 1, wherein the support frame comprises a plurality of support members configured to rotate with respect to each other, such that the support frame is selectively folded or expanded with respect to the foldable base.

8. The USB camera of claim 1, further comprising a height increasing member, wherein the height increasing member is connected to the bracket and the support frame is connected to the height increasing member after the support frame is detached from the bracket.

9. The USB camera of claim 1, wherein the at least one secondary plate abuts against the primary plate tightly when the at least one secondary plate is expanded with respect to the primary plate.
